(19) United States
(12) Patent Application Publication
(10) Pub. No.: US 2026/0312259 A1
(43) Pub. Date: Oct. 8, 2026

(54) FUSE UNIT AND CONDUCTIVE MODULE

(71) Applicant: YAZAKI CORPORATION, Tokyo (JP)

(72) Inventors: Katsunori Sato, Makinohara-shi (JP); Mariko Nakagawa, Makinohara-shi (JP); Yasuhiro Kominato, Makinohara-shi (JP); Miho Suzuki, Makinohara-shi (JP); Kota Morishige, Makinohara-shi (JP)

(21) Appl. No.: 19/529,134

(22) Filed: Feb. 4, 2026

(30) Foreign Application Priority Data
Feb. 5, 2025 (JP) 2025-017309

(51) Int. Cl. H01M 50/583; H01H 85/041; H01H 85/165; H01H 85/20

(52) U.S. Cl. CPC H01M 50/583; H01H 85/0411; H01H 85/165; H01H 85/205; H01H 2085/0414; H01M 2200/103

(57) ABSTRACT

A fuse unit includes a chip fuse including a first electrode, a second electrode, and a fusible portion; a first terminal fitting; a second terminal fitting; and a resin member that holds the first terminal fitting and the second terminal fitting. The first terminal fitting and the second terminal fitting respectively have a first width direction extending portion and a second width direction extending portion, which extend in a width direction. The resin member includes: a first holding portion (71a) that surrounds a periphery of the first width direction extending portion and holds the first width direction extending portion; and a second holding portion that surrounds a periphery of the second width direction extending portion and holds the second width direction extending portion.

### CROSS-REFERENCE TO RELATED APPLICATION(S)

The present application claims priority to and incorporates by reference the entire contents of Japanese Patent Application No. 2025-017309 filed in Japan on Feb. 5, 2025.

### BACKGROUND OF THE INVENTION

### 1. Field of the Invention

The present invention relates to a fuse unit and a conductive module.

### 2. Description of the Related Art

A conductive module includes a battery module in which a plurality of battery cells are arrayed, and electrically connects, in the battery module, the plurality of battery cells to each other using a plurality of connection conductors. In addition, the conductive module electrically connects individual connection conductors to a battery monitoring unit, a unit provided to monitor the battery state of the battery cell, using a wiring component such as an electrical cable. This type of conductive module is disclosed in the JP 2020-119 651 A, for example. In such a conductive module, there are cases where a combination, as a pair, of the connection conductor and a conductor portion of the wiring component is provided for each connection conductor, and a circuit protection component such as a fuse is interposed between the connection conductor and the conductor portion of the wiring component in each combination. For example, JP 7 561 318 B2 discloses a fuse unit (formed with a chip fuse, a pair of terminal fittings, and a resin member) applied to the conductive module.

The conventional fuse unit, in which the chip fuse is connected to the pair of terminal fittings formed with an insert-molded resin member, has room for improvement in bonding strength between the resin member and the terminal fittings. For example, when the bonding strength between the resin member and the terminal fittings is low, there is a concern that the connection between the terminal fitting and the chip fuse becomes unstable. For this reason, it is desired to develop a technique of increasing the bonding strength between the resin member and the terminal fitting.

### SUMMARY OF THE INVENTION

Therefore, an object of the present invention is to provide a fuse unit and a conductive module capable of increasing the bonding strength between a resin member and a terminal fitting.

In order to achieve the above mentioned object, a fuse unit according to one aspect of the present invention includes a chip fuse including a first electrode, a second electrode, and a fusible portion that is fused by overcurrent; a first terminal fitting having a plate shape and being connected to a connection target and to the first electrode; a second terminal fitting having a plate shape and connected to the second electrode; and a resin member that holds the first terminal fitting and the second terminal fitting and maintains an interval between the first terminal fitting and the second terminal fitting, wherein the first terminal fitting and the second terminal fitting each have a width direction extending portion extending in a width direction intersecting a connection direction, the connection direction being a direction of connection with the connection target, and the resin member includes a holding portion that surrounds a periphery of the width direction extending portion and holds the width direction extending portion.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a fuse unit and a conductive module according to an embodiment;

FIG. 2 is a schematic diagram illustrating a battery module together with a busbar;

FIG. 3 is a perspective view illustrating the fuse unit according to the embodiment;

FIG. 4 is an exploded perspective view illustrating the fuse unit of the embodiment;

FIG. 5 is an exploded perspective view illustrating the fuse unit of the embodiment;

FIG. 6 is an explanatory diagram of a modification of the fuse unit according to the embodiment;

FIG. 7 is an explanatory diagram of a modification of the fuse unit according to the embodiment; and

FIG. 8 is an explanatory diagram of a modification of the fuse unit according to the embodiment.

### DETAILED DESCRIPTION OF THE PREFERRED EMBODIMENTS

Embodiments according to the present invention will be described below in detail with reference to the drawings. Note that the present invention is not limited by the embodiment. Moreover, components in the following embodiment include those easily interchangeable by those skilled in the art or substantially identical.

### Embodiment

The present embodiment relates to a fuse unit and a conductive module. The following description uses a first direction, a second direction, and a third direction intersecting each other, in which the first direction is referred to as a “connection direction X”, the second direction is referred to as a “width direction Y”, and the third direction is referred to as a “height direction Z”. The connection direction X, the width direction Y, and the height direction Z are orthogonal to each other. The term “orthogonal” as used herein includes substantially orthogonal. The connection direction X corresponds to a direction in which the fuse unit is connected to the connection target. Unless otherwise specified, each direction used in the following description will be given as a direction in a state where the individual portions are assembled to each other.

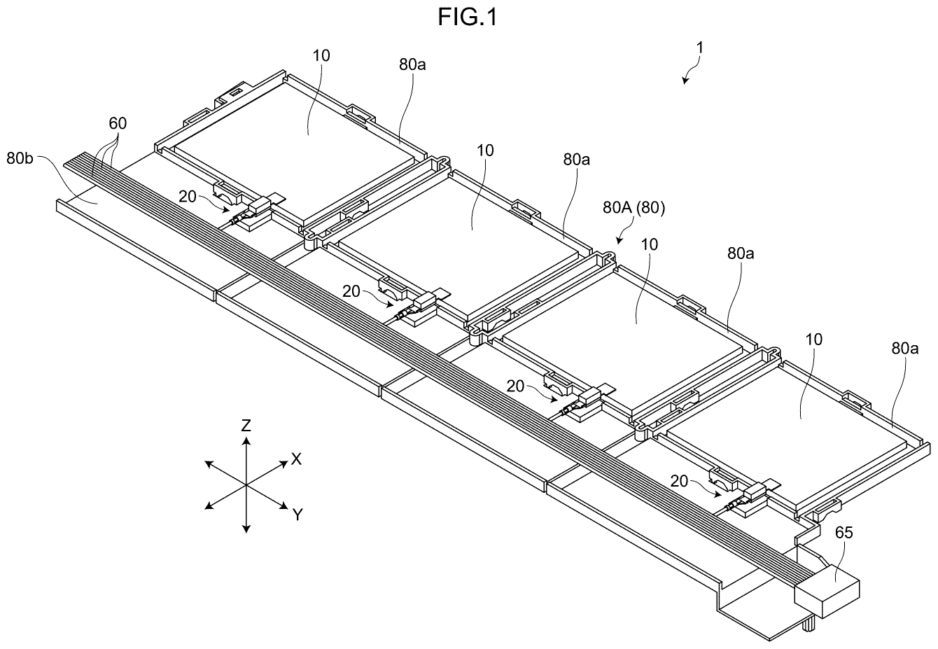

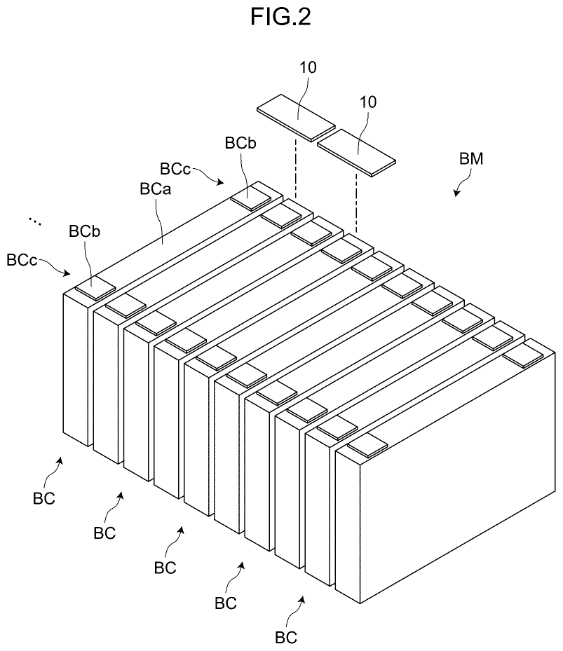

As illustrated in FIGS. 1 and 2, a conductive module 1 is assembled to a battery module BM in which a plurality of battery cells BC is arrayed, and electrically connects the plurality of battery cells BC in the battery module BM to each other. The conductive module 1 electrically connects the battery module BM to a battery monitoring unit (not illustrated) to allow the battery monitoring unit to monitor the battery state of the battery cell BC. The conductive module 1, together with the battery module BM, constitutes a battery pack. The battery pack is mounted on, for example, a vehicle (such as a Battery Electric Vehicle (BEV) and a Hybrid Electric Vehicle (HEV)) including a rotating machine as a drive source, and is used for purposes such as power supply to the rotating machine.

The battery cell BC includes a cell body BCa and electrode terminals BCb, provided as positive and negative terminals. In the battery module BM, the battery cells BC are arranged in plurality in a row along an array direction. The battery module BM includes: a one-side electrode terminal group BCc in which one-side electrode terminals BCb among the plurality of battery cells BC are disposed along the array direction; and an other-side electrode terminal group BCc in which other-side electrode terminals BCb among the plurality of battery cells BC are disposed along the array direction.

In the battery cell BC depicted here, the cell body BCa is formed in a rectangular parallelepiped shape having six outer wall surfaces. In the plurality of battery cells BC, the cell bodies BCa adjacent to each other in the array direction are disposed with one outer wall surface facing each other. For example, in the battery cell BC, the positive and negative electrode terminals BCb are disposed in one of the six outer wall surfaces of the cell body BCa or separately in two of the six outer wall surfaces of the cell body BCa. In this example, each battery cell BC includes the electrode terminals BCb, including positive and negative electrodes, on one of the six outer wall surfaces of the cell body BCa. Accordingly, the battery module BM has two electrode terminal groups BCc provided on one plane.

The electrode terminal BCb illustrated here is formed in a flat plate shape, and has a configuration to which a connection conductor 10 to be described below is directly electrically connected by laser welding, etc. However, the electrode terminal BCb may be formed in a pole shape having a male screw portion. In this case, a female screw member is screwed to the male screw portion of the electrode terminal BCb so as to fix, by screwing, the connection conductor 10 to the electrode terminal BCb.

The conductive module 1 includes the connection conductor 10 to be directly electrically connected to the electrode terminal BCb of the battery cell BC constituting the battery module BM.

The connection conductor 10 is formed of a conductive material such as metal. The connection conductor 10 is a plate-shaped conductive component formed with metal referred to as a bus bar, and is press-molded using a metal plate as a base material, for example. The connection conductor 10 depicted here is formed in a rectangular flat plate shape.

The conductive module 1 includes, as the connection conductors 10, for example: a connection conductor to be directly electrically connected to the adjacent electrode terminals BCb of the pair of battery cells BC in the battery module BM; a connection conductor to be directly electrically connected to the electrode terminal BCb to be a total negative electrode in the battery module BM; and a connection conductor to be directly electrically connected to the electrode terminal BCb to be a total positive electrode in the battery module BM.

The conductive module 1 includes the connection conductor 10 and a fuse unit 20. The fuse unit 20 is connected between the connection conductor 10 and the battery monitoring unit. The fuse unit 20 indirectly electrically connects between the connection conductor 10 and the battery monitoring unit, and interrupts energization when an overcurrent flows therebetween. The fuse unit 20 is provided for each connection conductor 10.

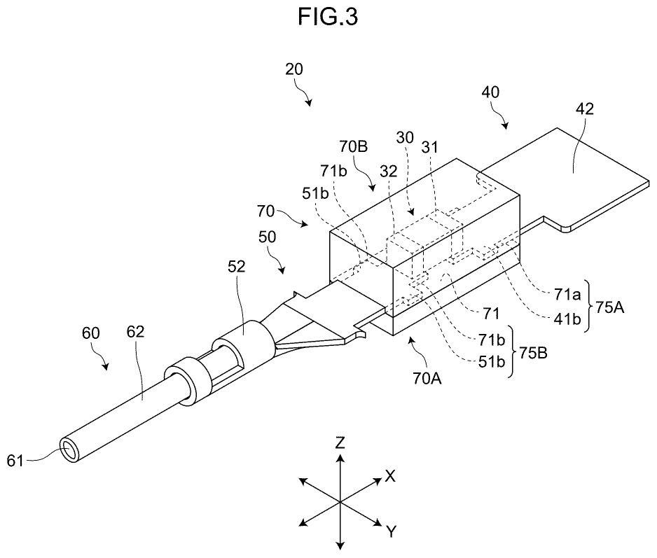

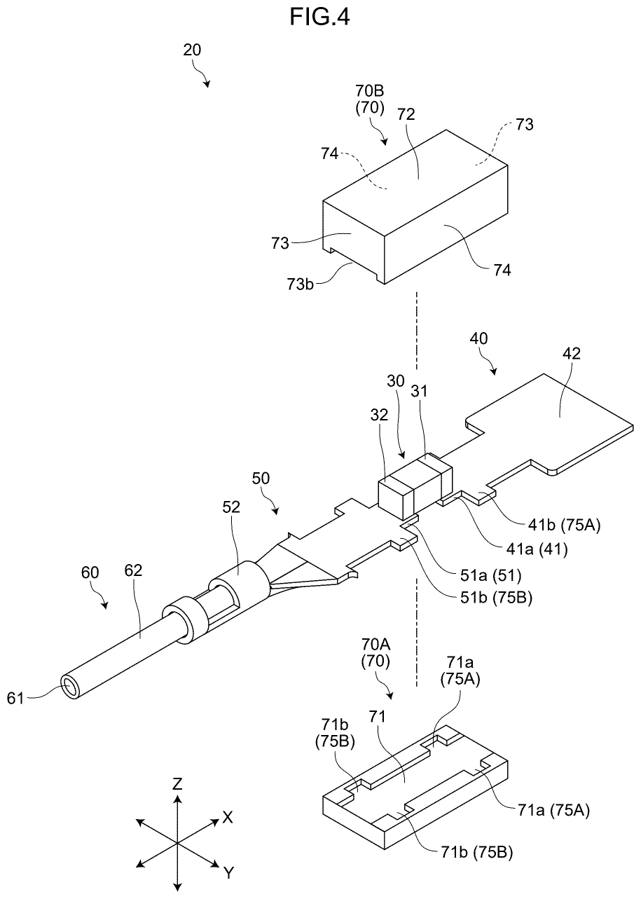

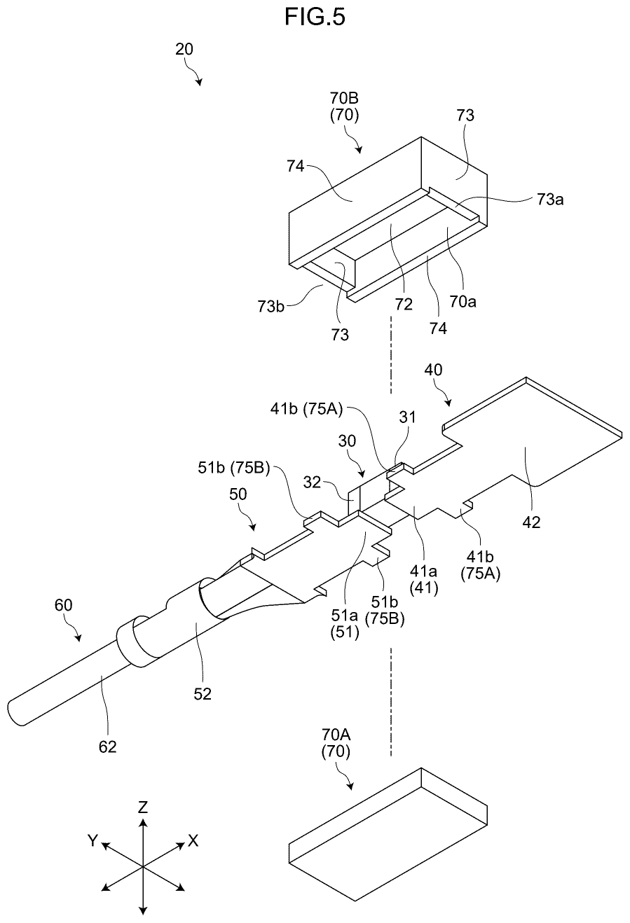

As illustrated in FIGS. 3 to 5, the fuse unit 20 includes a chip fuse 30, a first terminal fitting 40, a second terminal fitting 50, and a resin member 70. The chip fuse 30 is a circuit protection component that fuses a fusible portion when an overcurrent flows between the connection conductor 10 and the battery monitoring unit. The chip fuse 30 has a configuration in which the fusible portion is disposed between a first electrode 31 and a second electrode 32. The first electrode 31 and the second electrode 32 are disposed on a straight line separately at one end and the other end of the chip fuse 30.

The chip fuse 30 is configured as, for example, a surface-mountable chip component having a fusible portion, and may be configured as a pattern fuse in which a wiring pattern having a fusible portion is provided on a printed circuit board (for example, a flexible printed circuit board). The chip fuse 30 illustrated here is configured as a block-shaped chip component. The first electrode 31 is provided over five outer wall surfaces at one end of the chip fuse 30. The second electrode 32 is provided over five outer wall surfaces at the other end of the chip fuse 30.

The fuse unit 20 includes the first terminal fitting 40 and the second terminal fitting 50, which are directly electrically connected to the chip fuse 30. The first terminal fitting 40 and the second terminal fitting 50 are formed of a conductive material such as metal. For example, the first terminal fitting 40 and the second terminal fitting 50 have a plate shape, and are formed by press molding using a metal plate as a base material, for example.

The first terminal fitting 40 includes a first electrical connection portion 41 that is directly electrically connected to the first electrode 31 of the chip fuse 30. One of four outer wall surfaces of the first electrode 31 arranged in the circumferential direction is placed on the first electrical connection portion 41, directly electrically connecting the first electrode 31 to the first electrical connection portion 41 by laser welding, soldering, etc. Accordingly, the first electrical connection portion 41 is formed in a flat plate shape provided with a plane on which the outer wall surface of the first electrode 31 is placed. The first electrical connection portion 41 illustrated here is formed in a protruding flat plate shape, and the outer wall surface of the first electrode 31 is placed on a narrow part of the protruding portion. Among the first electrical connection portion 41, the narrow part serves as a contact portion 41a with the first electrode 31, allowing a direct electrical connection between the contact portion 41a and the first electrode 31.

Furthermore, the first terminal fitting 40 includes a conductor connecting portion 42 which is electrically connected to the connection conductor 10 directly or indirectly. The conductor connecting portion 42 is formed in a flat plate shape, and is placed on the connection conductor 10 with planes overlapping each other. The conductor connecting portion 42 is directly electrically connected to the connection conductor 10 by laser welding, ultrasonic bonding, etc. The conductor connecting portion 42 illustrated here is formed in a rectangular flat plate shape. The connection conductor 10 is a connection target to be connected with the first terminal fitting 40.

The first terminal fitting 40 illustrated here is molded in a single flat plate shape in which the first electrical connection portion 41 and the conductor connecting portion 42 are adjacent to each other.

The second terminal fitting 50 has a second electrical connection portion 51 that is directly electrically connected to the second electrode 32 of the chip fuse 30. One of four outer wall surfaces of the second electrode 32 arranged in the circumferential direction is placed on the second electrical connection portion 51, directly electrically connecting the second electrode 32 to the second electrical connection portion 51 by laser welding, soldering, etc. Accordingly, the second electrical connection portion 51 is formed in a flat plate shape provided with a plane on which the outer wall surface of the second electrode 32 is placed. The second electrical connection portion 51 illustrated here is formed in a protruding flat plate shape, and the outer wall surface of the second electrode 32 is placed on a narrow portion of this protruding portion. Among the second electrical connection portion 51, the narrow portion serves as a contact portion 51a with the second electrode 32, allowing a direct electrical connection between the contact portion 51a and the second electrode 32.

Furthermore, the second terminal fitting 50 is indirectly electrically connected to the battery monitoring unit. The fuse unit 20 includes a wiring component 60 interposed between the second terminal fitting 50 and the battery monitoring unit, allowing the second terminal fitting 50 to be indirectly electrically connected to the battery monitoring unit via the wiring component 60. The second terminal fitting 50 includes a wiring connecting portion 52 to be directly electrically connected to the wiring component 60.

The wiring component 60 includes a conductor portion 61 having one end directly electrically connected to the second terminal fitting 50 and the other end directly or indirectly electrically connected to the battery monitoring unit. The wiring component 60 includes an electrically insulating sheath 62 that covers the battery monitoring unit side from at least one end of the conductor portion 61 at the end. The wiring component 60 described here is a line-shaped conductor having a conductor portion 61 formed in a line shape. Specifically, the wiring component 60 is an electric wire in which a core wire as the conductor portion 61 is covered with the electrically insulating sheath 62, and directly electrically connects the wiring connecting portion 52 to one end of the conductor portion 61 at the end thereof.

For example, the electrically insulating sheath 62 of the wiring component 60 is peeled off at the terminal end of the wiring component 60 to expose one end of the conductor portion 61. In this case, it is allowable to apply, as the wiring connecting portion 52, a member formed as a caulking crimp portion to be caulked and crimped to one end (that is, the core wire of the terminal end of the electric wire) of the conductor portion 61. Alternatively, it is also allowable to use, for example, as the wiring component 60, a component in which one end of the conductor portion 61 is covered with the electrically insulating sheath 62 at the terminal end of the wiring component 60. In this case, it is allowable to apply, as the wiring connecting portion 52, a member formed as a pair of pressure contact blades to make a cut in the insulating sheath 62 at the terminal end of the wiring component 60 and sandwiches one end of the conductor portion 61 (the core wire of the terminal end of the electric wire). The wiring connecting portion 52 illustrated here is formed as a caulking crimp portion.

In the second terminal fitting 50 illustrated here, the second electrical connection portion 51 and the wiring connecting portion 52 are adjacent to each other. The wiring connecting portion 52 allows the wiring component 60 to be extracted in its adjacent direction and along the second electrical connection portion 51.

The wiring component 60 may be a flat wiring member such as a flexible printed circuit board in which the conductor portion 61 is formed as a wiring pattern. In this case, in the wiring component 60, the conductor portion 61 for each of the second terminal fittings 50 in the plurality of fuse units 20 is formed, and one end of the conductor portion 61 is provided at a terminal end of a branch portion branched from the main body for each second terminal fitting 50. The one end of the conductor portion 61 is directly electrically connected to the wiring connecting portion 52 by a method such as laser welding and soldering, for example.

In the fuse unit 20, the first electrical connection portion 41 of the first terminal fitting 40 and the second electrical connection portion 51 of the second terminal fitting 50 are disposed on a same plane at a predetermined interval. The predetermined interval corresponds to an interval (in other words, an inter-electrode pitch) between the first electrode 31 and the second electrode 32 in the chip fuse 30. Accordingly, the first terminal fitting 40 and the second terminal fitting 50 are disposed such that the interval between the first electrical connection portion 41 and the second electrical connection portion 51 matches the inter-electrode pitch between the first electrode 31 and the second electrode 32. The chip fuse 30 is installed across the first electrical connection portion 41 and the second electrical connection portion 51. Here, the first terminal fitting 40 and the second terminal fitting 50 are arranged such that the interval between the contact portion 41a of the first electrical connection portion 41 and the contact portion 51a of the second electrical connection portion 51 matches the inter-electrode pitch between the first electrode 31 and the second electrode 32. Therefore, the chip fuse 30 is installed across the contact portion 41a of the first electrical connection portion 41 and the contact portion 51a of the second electrical connection portion 51.

In addition, the first terminal fitting 40 illustrated here is disposed such that the adjacent direction of the first electrical connection portion 41 and the conductor connecting portion 42 matches the facing arrangement direction of the contact portions 41a and 51a. The second terminal fitting 50 illustrated here is disposed such that the adjacent direction of the second electrical connection portion 51 and the wiring connecting portion 52 matches the facing arrangement direction of each of the contact portions 41a and 51a.

The fuse unit 20 includes a resin member 70 that holds the first terminal fitting 40 and the second terminal fitting 50 and maintains an interval between the first terminal fitting 40 and the second terminal fitting 50. The resin member 70 is formed with an electrically insulating resin, and houses the first electrical connection portion 41, the second electrical connection portion 51, and the chip fuse 30, for example. Specifically, the resin member 70 includes a housing chamber 70a that houses the first electrical connection portion 41, the second electrical connection portion 51, and the chip fuse 30.

The resin member 70 includes a plurality of housing members assembled and fixed to each other to form the housing chamber 70a in the inside. The housing members, provided in plurality, are each formed of an electrically insulating material such as a synthetic resin. The housing members, provided in plurality, are molded as members separate from the first electrical connection portion 41, the second electrical connection portion 51, and the chip fuse 30, and surround the first electrical connection portion 41, the second electrical connection portion 51, and the chip fuse 30 to be housed in the housing chamber 70a.

Specifically, the resin member 70 illustrated here includes, as the plurality of housing members, a first housing member 70A and a second housing member 70B that sandwich the first electrical connection portion 41, the second electrical connection portion 51, and the chip fuse 30 between each other and house these portions in the housing chamber 70a.

The first housing member 70A has an installation surface 71 on which the first electrical connection portion 41 and the second electrical connection portion 51 are placed. The chip fuse 30 is placed on the first electrical connection portion 41 and the second electrical connection portion 51, which are placed on the installation surface 71. For example, the first housing member 70A is molded as a pedestal member for placing the first electrical connection portion 41 and the second electrical connection portion 51 on the installation surface 71. The first housing member 70A illustrated here is molded in a rectangular flat plate shape.

The second housing member 70B is molded as a cover member that covers the first electrical connection portion 41, the second electrical connection portion 51, and the chip fuse 30 at an assembly completion position with respect to the first housing member 70A as the pedestal member.

The second housing member 70B has a lid portion 72 which is disposed to face the installation surface 71 of the first housing member 70A across the first electrical connection portion 41, the second electrical connection portion 51, and the chip fuse 30 at the assembly completion position. The lid portion 72 illustrated here is formed in a rectangular flat plate shape, and is disposed parallel to the installation surface 71 of the first housing member 70A at the assembly completion position.

In addition, the second housing member 70B has a pair of first side wall portions 73 each being suspended from the lid portion 72 and being arranged to face each other with an interval in the facing arrangement direction of the contact portion 41a in the first electrical connection portion 41 and the contact portion 51a in the second electrical connection portion 51. The first side wall portion 73 illustrated here is formed in a rectangular flat plate shape, and has its side portion at the tip end abutted against the installation surface 71 of the first housing member 70A at the assembly completion position. However, the side portion of the tip end of one of the first side wall portions 73 has a first cutout 73a for extracting the conductor connecting portion 42 side of the first electrical connection portion 41 to the outside of the housing chamber 70a. Furthermore, the side portion of the tip end of the other of the first side wall portions 73 has a second cutout 73b for extracting the wiring connecting portion 52 side of the second electrical connection portion 51 to the outside of the housing chamber 70a.

In addition, the second housing member 70B has a pair of second side wall portions 74 each of which is suspended from the lid portion 72 and is disposed to face each other with an interval in a direction orthogonal to the facing arrangement direction of the lid portion 72 and the first housing member 70A and orthogonal to the facing arrangement direction of the contact portions 41a and 51a. The second side wall portion 74 illustrated here is formed in a rectangular flat plate shape, and has its side portion at the tip end abutted against the installation surface 71 of the first housing member 70A at the assembly completion position.

The second housing member 70B has an internal space surrounded by the lid portion 72, the pair of first side wall portions 73, and the pair of second side wall portions 74. In the resin member 70, when the first housing member 70A and the second housing member 70B are at the assembly completion position, the opening of the internal space of the second housing member 70B is closed by the first housing member 70A, allowing the internal space to be the housing chamber 70a.

For example, in the resin member 70, the side portion at the tip end of the pair of first side wall portions 73 and the side portion at the tip end of the pair of second side wall portions 74 are fixed to the installation surface 71 of the first housing member 70A at the assembly completion position by a method such as thermal welding.

In addition, it is desirable, for example, to form and fix the first housing member 70A and the second housing member 70B in a shape in which a gap therebetween can be eliminated at the assembly completion position so as to allow the housing chamber 70a to be a sealed space at the assembly completion position. With this configuration, the fuse unit 20 can suppress the intrusion of liquid, dust, etc. into the housing chamber 70a, making it possible to suppress deterioration in quality or durability due to the intrusion of the liquid or the like.

Here, there is provided, between the installation surface 71 of the first housing member 70A and the first electrical connection portion 41, a first positioning structure 75A configured to position the first electrical connection portion 41 with respect to the installation surface 71. In addition, there is provided, between the installation surface 71 of the first housing member 70A and the second electrical connection portion 51, a second positioning structure 75B configured to position the second electrical connection portion 51 with respect to the installation surface 71. The first positioning structure 75A and the second positioning structure 75B perform positioning of the first electrical connection portion 41 and the second electrical connection portion 51 by adjusting the interval between the contact portion 41a in the first electrical connection portion 41 and the contact portion 51a in the second electrical connection portion 51 to match an inter-electrode pitch between the first electrode 31 and the second electrode 32.

The first positioning structure 75A is configured with a first holding portion 71a and a first width direction extending portion 41b. The first holding portion 71a is formed in the first housing member 70A of the resin member 70. For example, a recess corresponding to the outer shape of the first terminal fitting 40 is formed on the installation surface 71 of the first housing member 70A, and a part of the recess serves as the first holding portion 71a. That is, the first holding portion 71a is formed by recessing the installation surface 71 of the first housing member 70A, and is formed in a shape to be fitted to the first width direction extending portion 41b. The first width direction extending portion 41b is formed on the first electrical connection portion 41 of the first terminal fitting 40, and is formed so as to protrude in the width direction Y from the end of the first housing member 70A in the width direction Y. In the first positioning structure 75A illustrated here, the first width direction extending portion 41b is formed in a rectangular shape, and accordingly, the first holding portion 71a is also a rectangular recess. Therefore, the first holding portion 71a surrounds the periphery of the first width direction extending portion 41b and is fitted to the first width direction extending portion 41b. With this configuration, the first holding portion 71a holds the first width direction extending portion 41b, and restricts the relative movement of the first housing member 70A and the first terminal fitting 40 in the connection direction X and the width direction Y. Therefore, the fuse unit 20 can increase the bonding strength between the resin member 70 and the first terminal fitting 40.

The first holding portion 71a and the first width direction extending portion 41b are formed in plurality. The plurality of first holding portions 71a and the plurality of first width direction extending portions 41b are provided so as to be fitted to each other. For example, the first width direction extending portion 41b is formed at two locations, each of which is formed so as to protrude in the width direction Y from either end in the width direction Y of the first housing member 70A. The first holding portion 71a is formed at two locations, each of which is formed to be fitted to each of the first width direction extending portions 41b.

The resin member 70 and the first terminal fitting 40 are firmly joined by the plurality of first holding portions 71a and the plurality of first width direction extending portions 41b fitted with each other, individually. For example, the resin member 70 and the first terminal fitting 40 can enhance bonding strength as compared with a case where one first holding portion 71a and one first width direction extending portion 41b are fitted and bonded.

Furthermore, the resin member 70 and the first terminal fitting 40 have a configuration in which the plurality of first holding portions 71a and the plurality of first width direction extending portions 41b are individually fitted to each other, making it possible to suppress relative rotation of the resin member 70 and the first terminal fitting 40 about fitting positions of the first holding portion 71a and the first width direction extending portions 41b, leading to achievement of the stabilized bonded state of the resin member 70 and the first terminal fitting 40.

The second positioning structure 75B is configured with a second holding portion 71b and a second width direction extending portion 51b. The second holding portion 71b is formed in the first housing member 70A of the resin member 70. For example, a recess corresponding to the outer shape of the second terminal fitting 50 is formed on the installation surface 71 of the first housing member 70A, and a part of the recess serves as the second holding portion 71b. That is, the second holding portion 71b is formed by recessing the installation surface 71 of the first housing member 70A, and is formed in a shape to be fitted with the second width direction extending portion 51b. The second width direction extending portion 51b is formed on the second electrical connection portion 51 of the second terminal fitting 50, and is formed so as to protrude in the width direction Y from the end of the first housing member 70A in the width direction Y. In the second positioning structure 75B illustrated here, the second width direction extending portion 51b is formed in a rectangular shape, and accordingly, the second holding portion 71b is also a rectangular recess. Therefore, the second holding portion 71b surrounds the periphery of the second width direction extending portion 51b and is fitted to the second width direction extending portion 51b. With this configuration, the second holding portion 71b holds the second width direction extending portion 51b, and restricts the relative movement of the first housing member 70A and the second terminal fitting 50 in the connection direction X and the width direction Y. Therefore, the fuse unit 20 can increase the bonding strength between the resin member 70 and the second terminal fitting 50.

The first housing member 70A is a plate body extending in the connection direction X, and is formed in a size including a region from a first forming position where the first width direction extending portion 41b of the first terminal fitting 40 is formed to a second forming position where the second width direction extending portion 51b of the second terminal fitting 50 is formed. By fitting the first holding portion 71a to the first width direction extending portion 41b and fitting the second holding portion 71b to the second width direction extending portion 51b, the first housing member 70A holds the first terminal fitting 40 and the second terminal fitting 50, and maintains the interval between the first terminal fitting 40 and the second terminal fitting 50.

The second holding portion 71b and the second width direction extending portion 51b are formed in plurality. The plurality of second holding portions 71b and the plurality of second width direction extending portions 51b are provided so as to be fitted to each other. For example, the second width direction extending portion 51b is formed at two locations, each of which is formed so as to protrude in the width direction Y from either end in the width direction Y of the first housing member 70A. The second holding portion 71b is formed at two locations, each of which is formed to be fitted to each of the second width direction extending portions 51b.

The resin member 70 and the second terminal fitting 50 are firmly joined by the plurality of second holding portions 71b and the plurality of second width direction extending portions 51b fitted with each other, individually. For example, the resin member 70 and the second terminal fitting 50 can enhance bonding strength as compared with a case where one second holding portion 71b and one second width direction extending portion 51b are fitted and bonded.

Furthermore, the resin member 70 and the second terminal fitting 50 have a configuration in which the plurality of second holding portions 71b and the plurality of second width direction extending portions 51b are individually fitted to each other, making it possible to suppress relative rotation of the resin member 70 and the second terminal fitting 50 about fitting positions of the second holding portion 71b and the second width direction extending portions 51b, leading to the stabilized bonded state of the resin member 70 and the second terminal fitting 50.

For example, in the fuse unit 20, the first electrical connection portion 41 and the second electrical connection portion 51 are installed on the installation surface 71 of the first housing member 70A. In the first electrical connection portion 41 and the second electrical connection portion 51, the interval between their contact portions 41a and 51a is adjusted to match the inter-electrode pitch between the first electrode 31 and the second electrode 32 by the first positioning structure 75A and the second positioning structure 75B. Therefore, in the fuse unit 20, by installing the chip fuse 30 in the contact portions 41a and 51a of the first electrical connection portion 41 and the second electrical connection portion 51, respectively, the first electrode 31 of the chip fuse 30 can be placed on the contact portion 41a of the first electrical connection portion 41, and the second electrode 32 of the chip fuse 30 can be placed on the contact portion 51a of the second electrical connection portion 51. In the fuse unit 20, the first electrode 31 and the contact portion 41a of the first electrical connection portion 41 is directly electrically connected by laser welding, soldering, or the like, and the second electrode 32 and the contact portion 51a of the second electrical connection portion 51 is directly electrically connected by laser welding, soldering, etc.

Here, in the fuse unit 20, the first housing member 70A is a pedestal member, and there is no portion such as a wall portion that covers the periphery of the first electrical connection portion 41, the second electrical connection portion 51, and the chip fuse 30 installed on the installation surface 71. Therefore, in the fuse unit 20, the laser irradiator and the soldering iron can be brought close to the first electrode 31 and the contact portion 41a of the first electrical connection portion 41 and to the second electrode 32 and the contact portion 51a of the second electrical connection portion 51 from various directions, and the laser light can be emitted from all directions between the first electrode 31 and the contact portion 41a and between the second electrode 32 and the contact portion 51a, or soldering can be performed therebetween from all directions by a soldering iron. Consequently, the fuse unit 20 can increase the degree of freedom in manufacturing when the first electrical connection portion 41, the second electrical connection portion 51, and the chip fuse 30 are directly electrically connected to each other.

Subsequently, in the fuse unit 20, the second housing member 70B is put on the first electrical connection portion 41, the second electrical connection portion 51, and the chip fuse 30, and then the first housing member 70A and the second housing member 70B at the assembly completion position are fixed by a method such as thermal welding. Here, it is assumed that the wiring component 60 is connected to the wiring connecting portion 52 of the second terminal fitting 50 in advance.

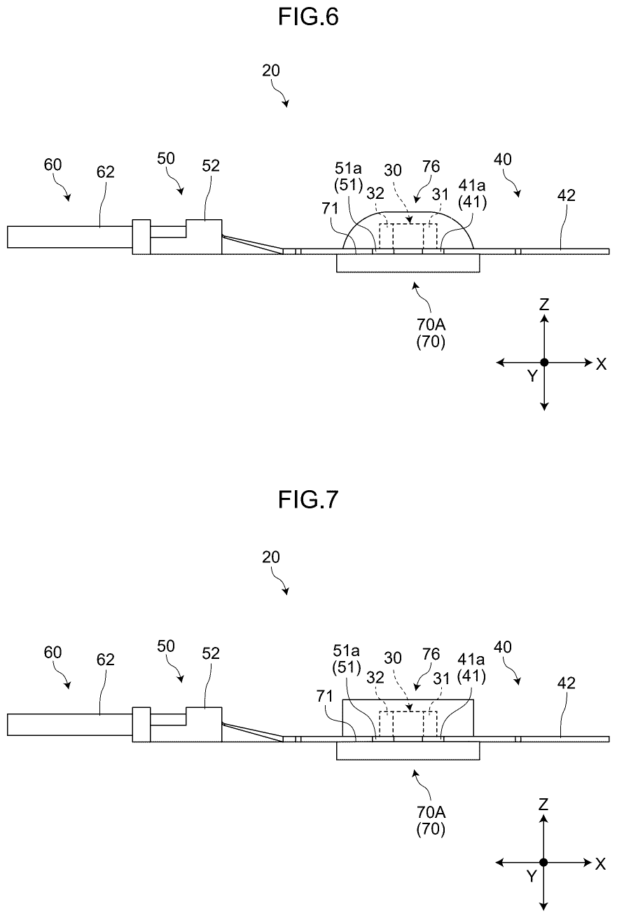

In the fuse unit 20, the first electrical connection portion 41, the second electrical connection portion 51, and the chip fuse 30 are exposed in the housing chamber 70a. Therefore, as illustrated in FIG. 6, the fuse unit 20 may include an electrically insulating sheath resin portion 76 enclosing the chip fuse 30, the first electrical connection portion 41, and the second electrical connection portion 51 in the housing chamber 70a. The sheath resin portion 76 encloses the chip fuse 30, the first electrical connection portion 41, and the second electrical connection portion 51 to suppress energization between the first electrical connection portion 41 and the second electrical connection portion 51. For example, even if dew condensation occurs in the housing chamber 70a, the sheath resin portion 76 can suppress a short circuit in the housing chamber 70a due to the dew condensation water. The sheath resin portion 76, when being fixed to the installation surface 71 of the first housing member 70A, can also function as a fixing member that fixes the first electrical connection portion 41, the second electrical connection portion 51, and the chip fuse 30 to the first housing member 70A in the housing chamber 70a.

For example, the sheath resin portion 76 is a solidified material of a liquid resin material (generally referred to as a potting material) supplied by dropping, etc. so as to enclose the chip fuse 30, the first electrical connection portion 41, and the second electrical connection portion 51. In this case, first, a liquid potting material is supplied to the chip fuse 30, the first electrical connection portion 41, and the second electrical connection portion 51 installed on the installation surface 71 of the first housing member 70A. Thereafter, according to the properties of the potting material, the potting material is irradiated with ultraviolet rays or heated to form the sheath resin portion 76 in which the potting material is cured. Since the sheath resin portion 76 undergoes such a manufacturing process, it is desirable to form the sheath resin portion using a liquid potting material having a viscosity that can be kept on the installation surface 71 until curing so that the liquid potting material does not flow out from the installation surface 71 of the first housing member 70A as the pedestal member before curing.

Here, in the case of the ultraviolet curing type potting material, it is necessary to bring the ultraviolet radiation device close to the liquid potting material. In the fuse unit 20, the first housing member 70A is a pedestal member, and there is no portion such as a wall portion that covers the periphery of the supplied liquid potting material. Therefore, in the fuse unit 20, the ultraviolet radiation device can be brought close to the liquid potting material from various directions on the installation surface 71 of the first housing member 70A, making it possible to apply the ultraviolet ray from all directions toward the liquid potting material. Therefore, the fuse unit 20 can increase the degree of freedom in manufacturing when forming the sheath resin portion 76.

Further, for example, the sheath resin portion 76 may be a solidified material that is filled in the housing chamber 70a and encloses the chip fuse 30, the first electrical connection portion 41, and the second electrical connection portion 51. In this case, for example, a supply hole (not illustrated) for supplying a liquid resin material to the inside (housing chamber 70a) of the first housing member 70A and the second housing member 70B at the assembly completion position is provided in either one of the first housing member 70A and the second housing member 70B. Here, when there is no gap between the first housing member 70A and the second housing member 70B at the assembly completion position (in other words, when the airtightness of the housing chamber 70a is high), either one of the first housing member 70A and the second housing member 70B is provided with an air vent hole (not illustrated) that releases the gas in the housing chamber 70a to the outside of the room during supply of the liquid resin material. In this case, a liquid resin material is supplied, via the supply hole, to fill the inside (housing chamber 70a) of the first housing member 70A and the second housing member 70B at the assembly completion position, and the resin material is cured to form the sheath resin portion 76. When there is a gap between the first housing member 70A and the second housing member 70B at the assembly completion position (in other words, the airtightness of the housing chamber 70a is low), or when there is a concern that the liquid resin material flows out of the housing chamber 70a, for example, when a supply hole or an air vent hole has to be provided vertically downward, it is desirable to form the sheath resin portion 76 using a liquid resin material having a viscosity that can be kept in the housing chamber 70a until curing.

In FIG. 1, the conductive module 1 includes an electrically insulating module resin portion 80 in which the fuse unit 20 is housed together with the connection conductor 10. The module resin portion 80 includes: an housing chamber that houses the connection conductor 10 (hereinafter, referred to as a “conductor housing chamber”) 80a; and an housing chamber that houses the fuse unit 20 (hereinafter referred to as a “unit housing chamber”) 80b.

For example, the module resin portion 80 includes a conductor housing chamber 80a for each of the connection conductors 10 connected to each of the electrode terminals BCb of the electrode terminal group BCc. On the other hand, the module resin portion 80 includes a unit housing chamber 80b that collectively houses the fuse units 20 for the individual connection conductors 10.

In the unit housing chamber 80b, the wiring component 60 (electric wire) of each fuse unit 20 is routed to the battery monitoring unit side. In each wiring component 60 (electric wire), the other end of the end routed to the battery monitoring unit side is connected to a connector 65 (FIG. 1). Each wiring component 60 (electric wire) is indirectly electrically connected to the battery monitoring unit via the connector 65.

When the wiring component 60 is a flat wiring member, the unit housing chamber 80b houses the wiring component 60 (flat wiring member) having the conductor portion 61 connected to the second terminal fitting 50 of each fuse unit 20 (not illustrated).

The module resin portion 80 includes: a first housing member (hereinafter, referred to as a “first module housing member”) 80A and a second housing member (hereinafter, referred to as a “second module housing member”, not illustrated), which are mutually assembled and fixed to form a plurality of the conductor housing chambers 80a and a plurality of the unit housing chambers 80b in the inside. The first module housing member 80A and the second module housing member are each molded of an electrically insulating material such as a synthetic resin.

The first module housing member 80A is provided with a space portion for forming the plurality of conductor housing chambers 80a and the unit housing chamber 80b at the assembly completion position with the second module housing member. The second module housing member is molded as a cover member that covers the opening of each space portion.

As described above, in the fuse unit 20 and the conductive module 1 of the present embodiment, the first width direction extending portion 41b of the first terminal fitting 40 is held by the first holding portion 71a of the resin member 70, and the second width direction extending portion 51b of the second terminal fitting 50 is held by the second holding portion 71b of the resin member 70, making it possible to increase the bonding strength between the first terminal fitting 40, the second terminal fitting 50, and the resin member 70.

In the fuse unit 20 and the conductive module 1 of the present embodiment, the first width direction extending portion 41b and the second width direction extending portion 51b are formed to protrude outward respectively from the ends of the first terminal fitting 40 and the second terminal fitting 50 in the width direction Y, making it possible to increase the bonding strength between the first terminal fitting 40 and the second terminal fitting 50 and the resin member 70, even with a simple structure.

In addition, the fuse unit 20 and the conductive module 1 according to the present embodiment include the first housing member 70A, which is formed to include a region from the first forming position where the first width direction extending portion 41b of the first terminal fitting 40 is formed to the second forming position where the second width direction extending portion 51b of the second terminal fitting 50 is formed. Therefore, in the fuse unit 20 and the conductive module 1 according to the present embodiment, the first holding portion 71a is fitted to the first width direction extending portion 41b, and the second holding portion 71b is fitted to the second width direction extending portion 51b, making it possible to hold the first terminal fitting 40 and the second terminal fitting 50 by the first housing member 70A and maintain the interval between the first terminal fitting 40 and the second terminal fitting 50.

In the fuse unit 20 and the conductive module 1 according to the present embodiment, the resin member 70 includes the sheath resin portion 76 provided so as to cover the chip fuse 30 and to be in contact with the first terminal fitting 40 and the second terminal fitting 50, making it possible to protect the chip fuse 30 more appropriately by the sheath resin portion 76.

The fuse unit and the conductive module according to the present invention are not limited to the above-described embodiments, and various modifications can be made within the scope described in the claims. The fuse unit 20 and the conductive module 1 according to the present embodiment may be configured by appropriately combining the components of the embodiments and the modifications described above.

For example, in the fuse unit 20 and the conductive module 1 according to the above-described embodiment, all or a part of the resin member 70 may be formed by resin molding. For example, as illustrated in FIG. 7, the sheath resin portion 76 covering the chip fuse 30 may be formed by resin molding. Specifically, the sheath resin portion 76 may be formed by insert molding an element as an insert, in which the first terminal fitting 40 and the second terminal fitting 50 are assembled to the first housing member 70A, and a component formed by connecting the chip fuse 30 is connected between the first terminal fitting 40 and the second terminal fitting 50. In addition, by performing insert molding in which the component formed by connecting the chip fuse 30 between the first terminal fitting 40 and the second terminal fitting 50 is used as the insert, the portion of the sheath resin portion 76 and the first housing member 70A may be formed. In this case, the resin molded portion in the resin member 70 is formed to enter between the first width direction extending portion 41b and the second width direction extending portion 51b, so as to include the first holding portion 71a and the second holding portion 71b. Therefore, even with such a fuse unit and conductive module, it is possible to increase the bonding strength between the first terminal fitting 40 and the second terminal fitting 50 and the resin member 70, similarly to the fuse unit 20 and conductive module 1 described above.

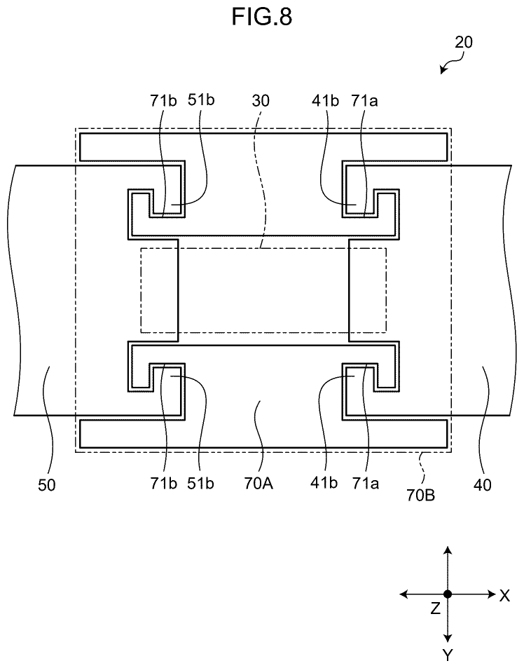

In the fuse unit 20 and the conductive module 1 according to the embodiment described above, the first width direction extending portion 41b and the second width direction extending portion 51b protrude outward from the ends in the width direction Y of the first terminal fitting 40 and the second terminal fitting 50, respectively. However, the first width direction extending portion 41b and the second width direction extending portion 51b may be formed inside the first terminal fitting 40 and the second terminal fitting 50, respectively. For example, as illustrated in FIG. 8, the first terminal fitting 40 may form a first cut portion recessed from an end in the connection direction X along the connection direction X and have the first width direction extending portion 41b that extends in the width direction Y with respect to the first cut portion, and the second terminal fitting 50 may form a second cut portion recessed from an end in the connection direction X along the connection direction X and have the second width direction extending portion 51b that extends in the width direction Y with respect to the second cut portion. For example, the first width direction extending portion 41b is formed in a hook shape that is bent from the end of the first terminal fitting 40 in the width direction Y toward a central portion. The first width direction extending portion 41b is formed at two locations, each of which is provided at either end of the first terminal fitting 40. The second width direction extending portion 51b is formed in a hook shape that is bent from the end of the second terminal fitting 50 in the width direction Y toward a central portion. The second width direction extending portion 51b is formed at two locations, each of which is provided at either end of the second terminal fitting 50. In the first housing member 70A, the first holding portion 71a is formed so as to be fitted to the first width direction extending portion 41b, and the second holding portion 71b is formed so as to be fitted to the second width direction extending portion 51b. Even with such a fuse unit and conductive module, it is possible to increase the bonding strength between the first terminal fitting 40 and the second terminal fitting 50 and the resin member 70, similarly to the fuse unit 20 and conductive module 1 described above.

According to the fuse unit and the conductive module of the present embodiment, the bonding strength between the resin member and the terminal fitting can be increased.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A fuse unit comprising:
a chip fuse including a first electrode, a second electrode, and a fusible portion that is fused by overcurrent;
a first terminal fitting having a plate shape and being connected to a connection target and to the first electrode;
a second terminal fitting having a plate shape and connected to the second electrode; and
a resin member that holds the first terminal fitting and the second terminal fitting and maintains an interval between the first terminal fitting and the second terminal fitting, wherein
the first terminal fitting and the second terminal fitting each have a width direction extending portion extending in a width direction intersecting a connection direction, the connection direction being a direction of connection with the connection target, and
the resin member includes a holding portion that surrounds a periphery of the width direction extending portion and holds the width direction extending portion.

2. The fuse unit according to claim 1, wherein
the width direction extending portion protrudes outward from the ends of the first terminal fitting and the second terminal fitting in the width direction.

3. The fuse unit according to claim 1, wherein
the first terminal fitting forms a first cut portion being a portion recessed along the connection direction from an end in the connection direction connected to the first electrode,
the second terminal fitting forms a second cut portion being a portion recessed along the connection direction from an end in the connection direction connected to the second electrode, and
the width direction extending portion is formed to extend in the width direction with respect to the first cut portion and the second cut portion in the first terminal fitting and the second terminal fitting.

4. The fuse unit according to claim 1, wherein
the resin member includes a first housing member formed as a plate body or a block body provided along the connection direction, and
the first housing member is formed to include a region from a first forming position where the width direction extending portion is formed in the first terminal fitting to a second forming position where the width direction extending portion is formed in the second terminal fitting, and the holding portion that holds the width direction extending portion is formed in the first housing member.

5. The fuse unit according to claim 2, wherein
the resin member includes a first housing member formed as a plate body or a block body provided along the connection direction, and
the first housing member is formed to include a region from a first forming position where the width direction extending portion is formed in the first terminal fitting to a second forming position where the width direction extending portion is formed in the second terminal fitting, and the holding portion that holds the width direction extending portion is formed in the first housing member.

6. The fuse unit according to claim 3, wherein
the resin member includes a first housing member formed as a plate body or a block body provided along the connection direction, and
the first housing member is formed to include a region from a first forming position where the width direction extending portion is formed in the first terminal fitting to a second forming position where the width direction extending portion is formed in the second terminal fitting, and the holding portion that holds the width direction extending portion is formed in the first housing member.

7. The fuse unit according to claim 1, wherein
the resin member includes a sheath resin portion that is provided to cover the chip fuse and is to be in contact with the first terminal fitting and the second terminal fitting, the sheath resin portion being formed by curing a liquid or a fluid.

8. The fuse unit according to claim 2, wherein
the resin member includes a sheath resin portion that is provided to cover the chip fuse and is to be in contact with the first terminal fitting and the second terminal fitting, the sheath resin portion being formed by curing a liquid or a fluid.

9. The fuse unit according to claim 3, wherein
the resin member includes a sheath resin portion that is provided to cover the chip fuse and is to be in contact with the first terminal fitting and the second terminal fitting, the sheath resin portion being formed by curing a liquid or a fluid.

10. A conductive module comprising:
a connection conductor electrically connected to an electrode terminal of a battery cell constituting a battery module; and
a fuse unit that electrically connects the connection conductor to a battery monitoring unit that monitors a battery state of the battery cell, wherein
the fuse unit includes:
a chip fuse including a first electrode, a second electrode, and a fusible portion that is fused by overcurrent;
a first terminal fitting having a plate shape and being connected to a connection target and to the first electrode;
a second terminal fitting having a plate shape and being configured to be connected to the second electrode; and
a resin member that holds the first terminal fitting and the second terminal fitting and maintains an interval between the first terminal fitting and the second terminal fitting,
the first terminal fitting and the second terminal fitting each have a width direction extending portion extending in a width direction intersecting a connection direction, the connection direction being a direction of connection with the connection target, and
the resin member includes a holding portion that surrounds a periphery of the width direction extending portion and holds the width direction extending portion.
